(19) United States
(12) Patent Application Publication
(10) Pub. No.: US 2013/0135104 A1
(43) Pub. Date: May 30, 2013

(54) RADIO-FREQUENCY TRANSPONDER COMPRISING A TAMPER LOOP FUNCTIONALITY

(71) Applicant: Mikko NIKKANEN, Tampere (FI)

(72) Inventor: Mikko NIKKANEN, Tampere (FI)

(73) Assignee: UPM RFID OY, Pirkkala (FI)

(21) Appl. No.: 13/306,445

(22) Filed: Nov. 29, 2011

(51) Int. Cl. G08B 13/14; G06K 19/073

(52) U.S. Cl. 340/572.1; 235/492

(57) ABSTRACT

The application discloses a radio-frequency transponder having a tamper loop functionality the state of which is readable. The radio-frequency transponder comprises attaching means comprising at least one pin and a counterpart for the pin. The attaching means is configured to attach said radio-frequency transponder to an item by means of the pin and the counterpart. The attaching means is configured to create the tamper loop for the radio-frequency transponder when the pin is in contact with the counterpart. The application also discloses a method for monitoring such a radio-frequency transponder.

### FIELD OF THE INVENTION

This invention relates generally to a radio-frequency transponder, and in particular such a radio-frequency transponder that comprises a tamper loop functionality. In addition the present invention relates to a method for monitoring a radio-frequency transponder.

### BACKGROUND OF THE INVENTION

RFID (Radio Frequency Identification) transponders are utilized in consumer products to identify such a product among other products but also to give information on the product. The RFID transponder can be attached to the product, such as a clothing, a book, an electronic device, etc. Traditionally RFID transponder have been in many applications attached as adhesive tags. In addition, RFID transponders can be used for preventing shoplifting. In such applications, the RFID transponder may be hidden into the product or attached to the product in such way that it cannot be removed without breaking the transponder. When an item having an RFID transponder is legally bought, at the time of payment, the cashier disables the RFID transponder which until that time has been functional. In other words, if an RFID transponder on the item hasn't been disabled at the cashier, such an item can be later detected by a reader when the item is illegally removed from the store, which in turn may cause an alarm. However, if the transponder has been removed so that the antenna of the RFID transponder has been broken apart or been damaged, the reader is not further capable of reading or detecting the transponder in question. Therefore, further development in this area is needed in order to ensure that simply making the RFID transponder electrically inoperable cannot be used to avoid the alarm.

### SUMMARY OF THE INVENTION

The object of the present invention is to provide a RFID transponder which is detectable even if being damaged or altered to provide better possibilities to enquire its status and presence in different situations such as before cashier, at the cashier or after the cashier. This object is achieved with a radio-frequency transponder having a tamper loop functionality the state of which is readable. This object is also achieved with a method for monitoring such a radio-frequency transponder.

According to a first aspect, there is provided a radio-frequency transponder having a tamper loop functionality the state of which is readable, which radio-frequency transponder comprises attaching means comprising at least one pin and a counterpart for said pin. The attaching means are configured to attach said radio-frequency transponder to an item by means of said at least one pin and said counterpart, wherein said attaching means is configured to create the tamper loop for said radio-frequency transponder when said at least one pin is in contact with said counterpart.

According to an embodiment the attaching means comprises two parts.

According to an embodiment a first part of said attaching means comprises said at least one pin, and a second part of said attaching means comprises the counterpart.

According to an embodiment the counterpart comprises a corresponding number of holes for said at least one pin.

According to an embodiment the radio-frequency transponder comprises a radio-frequency inlay in said first part, said radio-frequency inlay comprising an integrated circuit and an antenna.

According to an embodiment the integrated circuit comprises connections for said tamper-loop.

According to an embodiment the integrated circuit comprises a memory configured to store status information on said tamper-loop.

According to an embodiment the integrated circuit is readable in order to return said status information to a reader.

According to a second aspect there is provided a method for monitoring a radio-frequency transponder comprising attaching means being configured to attach the radio-frequency transponder to an item by means of at least one pin and a counterpart for said pin, which attaching means are configured to create a tamper-loop for said transponder, wherein the method comprises polling the transponder by at least one reader, and as a result of said polling, receiving information indicating the status of the tamper-loop of the transponder.

According to an embodiment of the method whether the status information being received indicates that the tamper-loop of the transponder is tampered, wherein the method comprises producing an alarm.

According to an embodiment of the method the alarm is a silent alarm.

According to an embodiment of the method the alarm is an audible alarm.

In the above aspects, various combinations of the embodiments are possible.

### DESCRIPTION OF THE DRAWINGS

In the following, various embodiments of the invention will be described in more detail with reference to the appended drawings, where

FIG. 1 illustrates a radio-frequency transponder comprising attaching means according to an embodiment,

FIG. 2 illustrates a radio-frequency transponder according to an embodiment being attached to an item,

FIG. 3 illustrates a first part of attaching means according to an embodiment

FIG. 4 illustrates a radio-frequency inlay according to an embodiment,

FIG. 5 illustrates a second part of attaching means according to an embodiment,

FIG. 6 illustrates a radio-frequency transponder with a completed tamper-loop functionality, and

FIGS. 7a-7e illustrate a radio-frequency transponder comprising attaching means according to other embodiments.

### DETAILED DESCRIPTION OF THE INVENTION

This invention concerns a radio-frequency transponder having a tamper loop functionality. Such a transponder can be used for antitheft but also for radio frequency based data transmission. The radio-frequency transponder can be based on RFID technology.

The radio-frequency transponder comprises attaching means, by means of which the radio-frequency transponder can be attached to an item, for example a clothing. According to an embodiment, the attaching means comprises two components, wherein a first component of said attaching means comprises two pins and a second component of said attaching means comprises two holes for said two pins as a counterpart. In order to attach the radio-frequency transponder to an item, the first and second components of the attaching means are placed on opposite sides of a sheetlike (the thickness of which is less than height of the pins) item (e.g. a clothing, a fabric), and fixed together with connection pins. The connection pins on said first component are brought through the item so that the pin ends are on the same side with the second component. The pins are placed in the holes of the second component, and the parts are then pressed together so that the item is kept between them. The connection pins can be opened with a certain tool at the checkout desk to remove the radio-frequency transponder from the item.

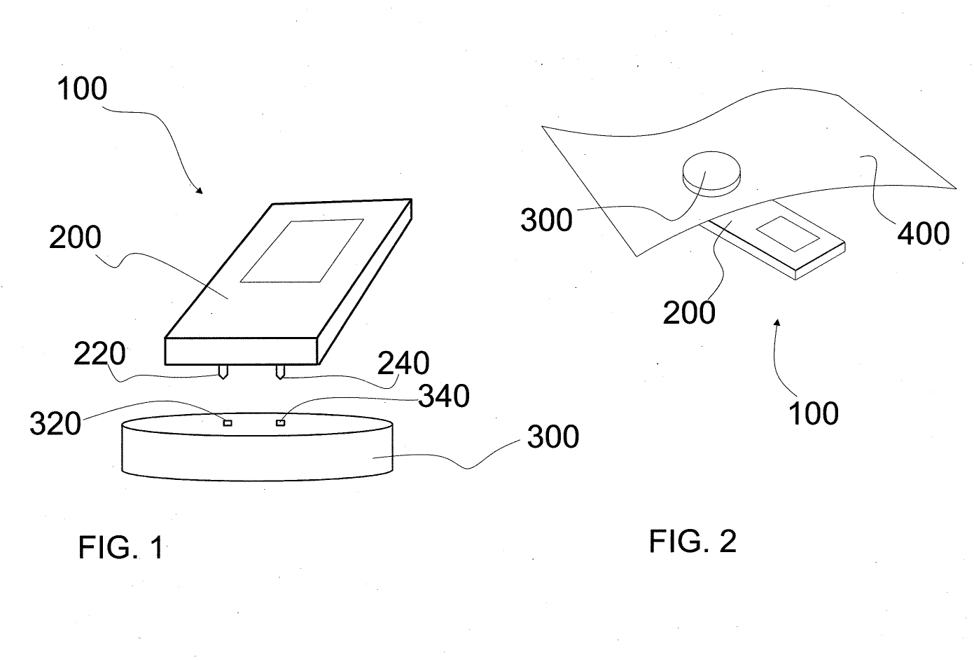

FIG. 1 illustrates an example of a radio-frequency transponder 100 according to an embodiment of the present invention. The radio-frequency transponder 100 comprises attaching means being formed of two components, a first component 200 and a second component 300. The first component 200 has two connection pins 220, 240, which pins 220, 240 are used for attaching the radio-frequency transponder 100 to an item. The second component 300 has two holes 320, 340 as counterpart for the pins 220, 240, whereby the second component 300 is capable of locking the attaching means to the item when pressed against the first component 200.

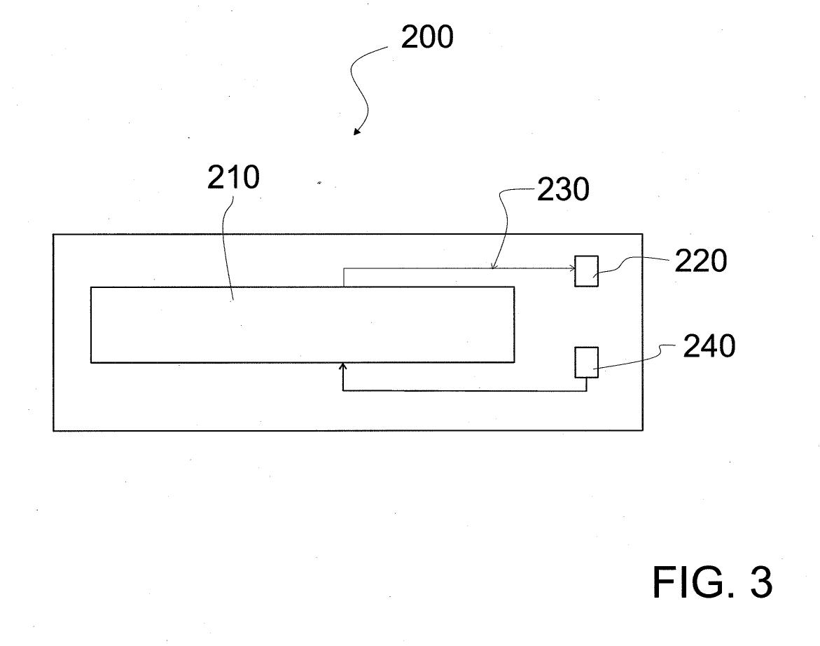

FIG. 2 illustrates a radio-frequency transponder 100 being attached to an item 400. As can be realized from the figure, that the radio-frequency transponder 100 is fixed to the item 400 by means of components 200, 300 of the attaching means. In FIG. 2, the pins, shown in FIG. 1 with reference 220, 240, are placed in the holes, shown in FIG. 1 with reference 320, 340, to attach the components 200, 300 together with the item 400 being placed between them.

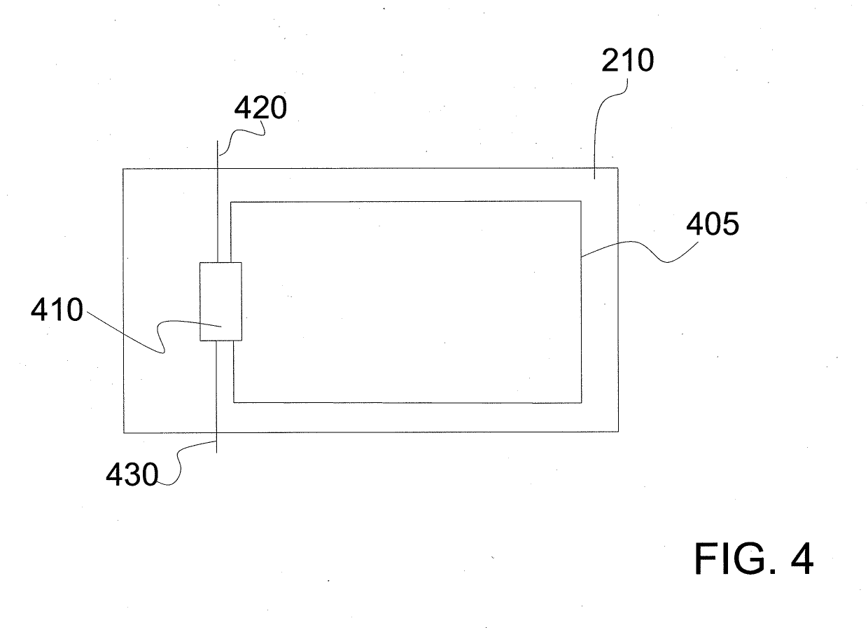

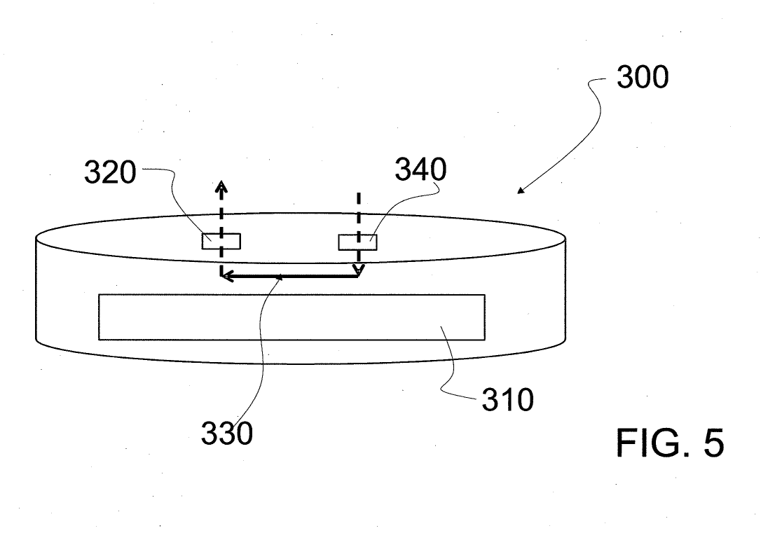

FIG. 3 illustrates an example of a first component 200. The first component 200 comprises an radio-frequency transponder inlay 210 which is illustrated in more detailed manner in FIG. 4. As shown in FIG. 4, the radio-frequency transponder inlay 210 comprises an integrated circuit (IC) 410 and an antenna 405 being connected to the integrated circuit 410. In addition to these elements, the radio-frequency transponder inlay 210 comprises a tamper loop connections 420, 430 being connected at their other ends to the integrated circuit 410.

An example of a chip being capable of creating a tamper-loop has been introduced by NXP Seminconductors. Such a chip type is called NXP G2iL+, and it comprises internal means for utilizing external tamper-loop. The present solution is targeted to providing means to implement the external loop.

The radio-frequency transponder of this example is so called passive radio-frequency transponder. This means that the radio-frequency transponder does not have an internal power supply or battery of its own but the power required to energize the transponder is obtained from the electromagnetic field created by a reader device used to interrogate the transponder. In addition to the passive transponders, also active or semipassive radio-frequency transponders exist. Such transponders have internal batteries to power their circuits. The difference between active and semipassive radio-frequency transponders is that the active radio-frequency transponder can also use the internal battery to power broadcasting to the reader. Semipassive radio-frequency transponder, on the other hand, uses the internal battery only for powering the circuit, whereby the broadcasting is energized by the reader.

Turning back to FIG. 3, the first component 200 comprises the radio-frequency transponder inlay 210 and pins 220, 240 for attaching the first component 200 to the second component 300. FIG. 3 also shows a part of a tamper loop functionality 230 that originates from one of the tamper loop connections (420, 430 in FIG. 4) in the radio-frequency transponder inlay 210 and goes towards the pin 220.

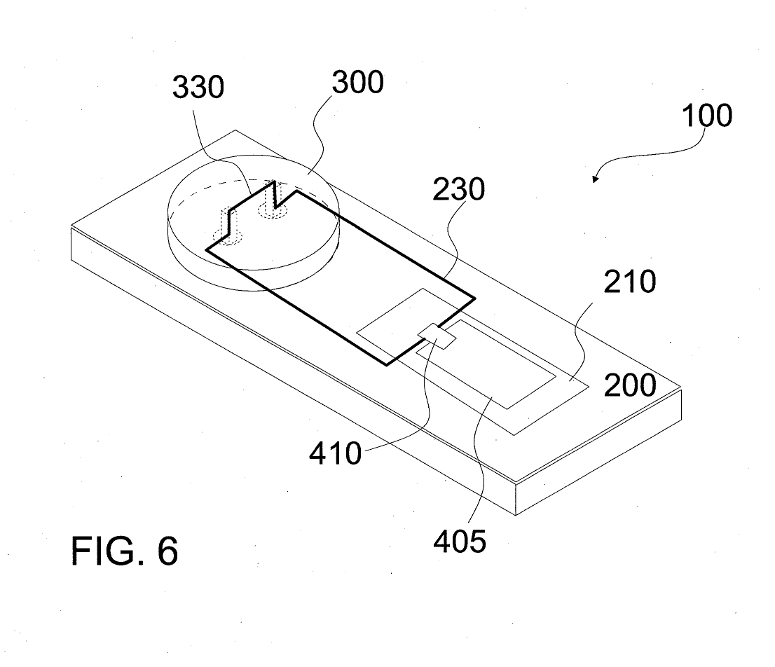

It can be realized that the tamper loop is extended from the radio-frequency transponder inlay 210 with the connection pins 220, 240 which, in use, are connected to the second component 300. A detailed illustration of an example of the second component 300 is shown in FIG. 5. The second component 300 has holes 320, 340 configured to receive the pins 220, 240 (shown in FIG. 3). When the pins are placed within the holes 320, 340, the connection pins are connected to a coupling 330, whereby the entire tamper loop is completed. The pins are thus part of complete tamper loop functionality. According to FIG. 5, the second component 300 may have an additional EAS (Electronic Article Surveillance) functionality, such as an EAS tag. Such an EAS tag causes alarm, when a product with the EAS tag is passed through a gates acting as an EAS alarm system and being configured to detect such a tag. It is appreciated that the transponder according to this invention does not need any EAS tags, because the RFID transponder having a tamper loop system may replace completely these EAS tags. However, for some high-cost products a double-surveillance with EAS tags and RFID transponders with tamper-loop may come into question.

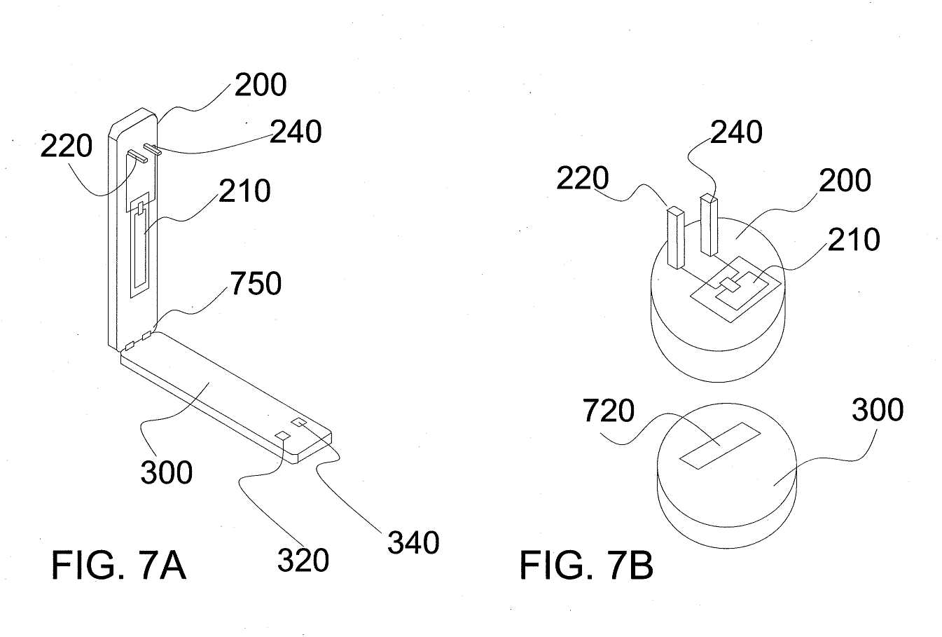

FIG. 6 illustrates an example of the radio-frequency transponder 100 having a first component 200 being attached to a second component 300, whereby a tamper loop circuit 230, 330 is completed. Now, when the second component 300 is removed from the first component 200, the complete tamper loop circuit 230, 330 breaks. The tamper loop is readable by the integrated chip 410. This means, that if the loop 230, 330 is open, a memory location of the integrated circuit chip 410 is written, for example, with “0”. If the loop 230, 330 is galvanically closed, the memory location of the chip 410 is written with “1”.

As long as the antenna 405 of the transponder 100 is undamaged, the state of the tamper-loop 230, 330 can be detected by the reader from the integrated circuit 410. By this, any attempts to remove such a transponder from a product for shoplifting purposes, can be detected by the reader because the state of the tamper bit is changed and can be seen if the tag is polled by the reader on regular basis. Therefore, the transponder is not just disappeared from the reader field, as the conventional transponders having a broken antenna, but the reader can still detect the transponder, can identify the product to which the transponder was attached to and can determine where the transponder is situated. This can create an alarm, which will direct the staff of the store to go and see what is happening with the transponder in the given situation and shop location.

The tamper loop 230, 330, which may also be referred to as a tamper-evidence loop, may be any kind of galvanically connected structure, for example wire or film or even conductive liquid, the break of which can be detected by the integrated circuit 410. The tamper loop 230, 330 may be of aluminum, copper, silver, conductive polymeric material, or another suitable conductive material. In many cases the tamper loop can implemented by etching a conducting structure of a metal film on a polymer substrate. The integrated circuit 410 comprises specific connectors for the tamper loop 230. Conductive materials having at least some elasticity may also be applied. For example, the tamper loop 230, 330 may be implemented by conductive ink or paste, or another suitable conductive material with some elasticity. Since the tamper loop 230 is separate from the antenna 405, the RFID transponder may still be operative after tampering and the original information may be readable by an radio-frequency transponder reader. The integrated circuit 410 may be configured to detect break of the tamper loop 230, 330. After detecting the break of the tamper loop, at least one indicative bit may change status in the integrated circuit 410, and the integrated circuit 410 may be configured to return a specific code to indicate tampering during transponder reader interrogation.

With the transponder having a tamper loop circuit according to the present solution it is possible to identify if someone detaches the attaching means intentionally without paying the product to the cashier. In a normal purchasing situation, the cashier will remove the transponder automatically based on paid status. However, the transponder will break down, if one or both the pins are disconnected from the tamper loop. The status of the transponder then changes its status from “undamaged” to “tampered” being indicated by at least one indicative bit and it will be remain as “tampered” until formatting is done by a compatible system based readers. Fitting rooms, but also other premises of the store where buyers can travel without monitoring, can be equipped with readers which will recognize the changes in status of items and as a response to the recognition, will start an alarm.

The transponders according to the invention improve the control and monitoring of the products in stores, because the status of the transponder in a product can be identified before the product with the transponder passes the gate. The status can be monitored with a reader, which tells which transponder is in question, where and when the transponder was tampered. Such an information causes an alarm (audible or silently) e.g. at the cash desk, as a result of which the personnel can perform the needed actions. For example, if an alarm originates from a fitting-room, the alarm may be silent and the personnel may approach the client in the fitting-room calmly. However, an alarm originating from the gate may be audible to arouse attention.

Automatic cash desks without a salesperson are already used in some stores, but in the future, this trend will continue. One problem with the automatic cash desks is a temptation for a buyer to detach the price tag of a low-priced product and to place that tag to a higher-priced product. This kind of an action can be prevented with the transponder of this invention which is detectable even if being damaged. The tamper-bit indicating the status of the transponder clearly shows, whether the transponder has been moved.

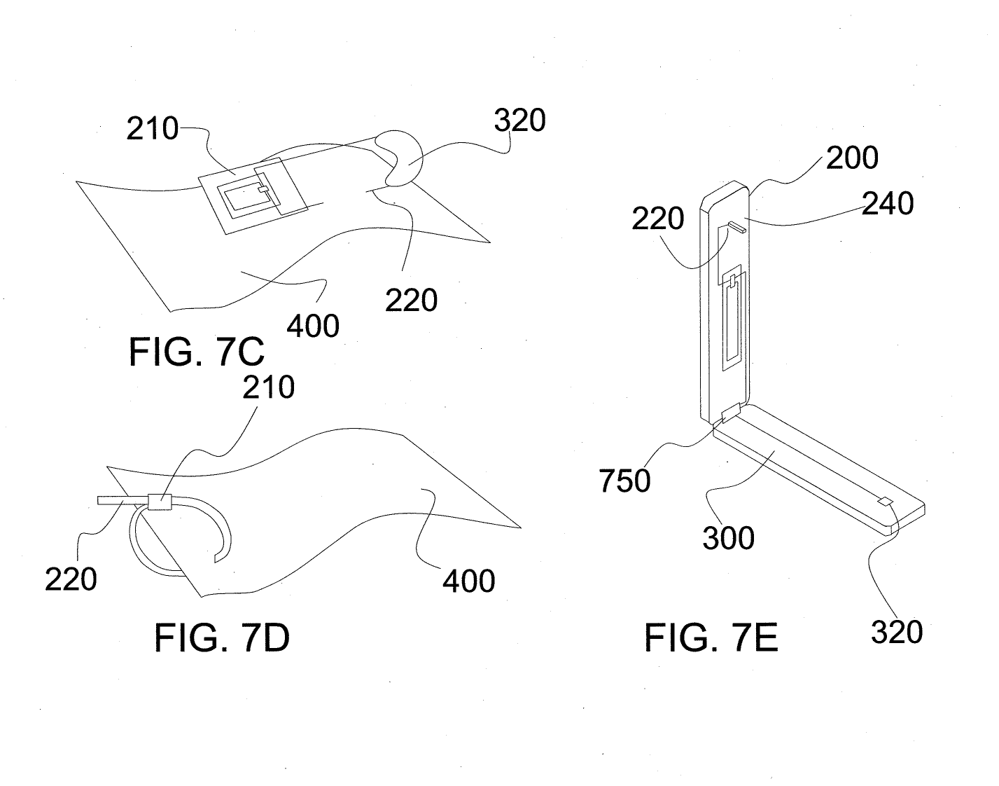

FIGS. 7a-7e illustrate various examples of other structural embodiments for the radio-frequency transponder. In the previous examples, the attaching means are formed of two separated components, wherein the shapes of said parts deviate from each other. In FIG. 7a, the attaching means is formed of two components 200, 300 being hinged 750 together at their other ends. In FIG. 7b, the both components 200, 300 of said attaching means are cylindrical elements that are connectable together. Yet as a further modification of a transponder, FIG. 7b shows that the holes acting as a counterpart for pins 220, 240 is replaced with a counterpart element 720. The counterpart element 720 is a notch for receiving both of the pins 220, 240 and has a coupling for completing the tamper-loop at the bottom of the notch.

FIG. 7c shows an embodiment resembling a safety pin. In such a structure a pin 220 and a transponder 210 are formed as a single component. The pin 220 is pushed through the item 400 (e.g. clothing) and then back to the side, where the transponder 210 is situated. The pin 220 is then fastened to the notch 320 of the transponder, which notch 320 acts as a counterpart for the pin 220. As in the other embodiments, this kind of a transponder would cause an alarm immediately when the pin 220 is illegally being removed from the notch 320.

FIG. 7d shows yet another embodiment of the transponder as a single component structure. This kind of a transponder resembles a cable tie. As in FIG. 7c, the pin 220 is pushed through the item 400. However, in this example, the transponder 210 goes around to the other side over the edge of the item 400 in order to receive the pin 220. It is realized that transponder 210 acts as an counterpart for the pin 220 in this example. Also this kind of a transponder can be attached quickly to the item. It is realized that the previous transponders are reusable, however this kind of a structure could be disposable. This means that in order to detach the cable tie like a structure, the transponder should be cut out.

These structures have further advantages in the way they are detached. Because the transponders of such types can be removed manually or with scissors, no additional device for removal is needed. In a case of shoplifting, the alarm is caused immediately after the loop connection is broken.

The transponder of FIG. 7A can also be modified towards a structure having only one pin, as shown in FIG. 7E. In such a structure, the hinge 750 between components 200, 300 could act as a part of the loop, whereby only one hinge would be enough. This kind of a transponder can be easily attached to the edge of the clothing by one pin 220. However, in order to remove the transponder of this kind, a detacher is needed.

In all the previous embodiments, the pin can be locked to the counterpart in any known ways. These include e.g. magnetic locks that are opened with a magnetic detacher.

By understanding these different embodiments, the skilled person appreciates that the attaching means can be even further modified. In addition the shape and configuration of the components can deviate greatly from what has been presented. The main parts of the attaching means can be separated or connected. The attaching means can also comprise more than two parts if enhanced functionality is needed for the operation of the radio-frequency transponder. In addition, there can be one pin and a hole in a first component, and one pin and a hole in a second component, whereby the pin of the first component is received by the hole of the second component, and whereby the pin of the second component is received by the hole of the first component. The tamper loop can then be created in a similar manner as in the previous examples.

The tag having a tamper loop circuit represents a substantial advancement in the construction of a antitheft tag as to its operational reliability. In addition, the construction makes the violent removing of the tag at least twice as hard compared to traditional hard tags because of the double number of pins. The invention is characterized by having two pins in a transponder, which makes the transponder difficult to remove. In addition, the tampering will change the status of the transponder which status is readable and recognizable with a reader.

1. A radio-frequency transponder having a tamper loop functionality the state of which is readable, the radio-frequency transponder comprising attaching means comprising at least one pin and a counterpart for said pin, said attaching means being configured to attach said radio-frequency transponder to an item by means of said at least one pin and said counterpart, wherein said attaching means is configured to create the tamper loop for said radio-frequency transponder when said at least one pin is in contact with said counterpart.

2. The radio-frequency transponder according to claim 1, wherein said attaching means comprises two parts.

3. The radio-frequency transponder according to claim 2, wherein a first part of said attaching means comprises at least one pin, and wherein a second part of said attaching means comprises the counterpart.

4. The radio-frequency transponder according to claim 1, wherein the counterpart comprises a corresponding number of holes for said at least one pin.

5. The radio-frequency transponder according to claim 2, comprising a radio-frequency inlay in said first part, said radio-frequency inlay comprising an integrated circuit and an antenna.

6. The radio-frequency transponder according to claim 5, wherein said integrated circuit comprises connections for said tamper-loop.

7. The radio-frequency transponder according to claim 6, wherein the integrated circuit comprises a memory configured to store status information on said tamper-loop.

8. The radio-frequency transponder according to claim 7, wherein the integrated circuit is readable in order to return said status information to a reader.

9. A method for monitoring a radio-frequency transponder comprising attaching means being configured to attach the radio-frequency transponder to an item by means of at least one pin and a counterpart for said pin, which attaching means are configured to create a tamper-loop for said transponder, wherein the method comprises polling the transponder by at least one reader, and as a result of said polling, receiving information indicating the status of the tamper-loop of the transponder.

10. The method according to claim 9, wherein whether the status information being received indicates that the tamper-loop of the transponder is tampered, wherein the method comprises producing an alarm.

11. The method according to claim 10, where the alarm is a silent alarm.

12. The method according to claim 10, where the alarm is an audible alarm.
